(19) United States
(12) Patent Application Publication
(10) Pub. No.: US 2026/0338136 A1
(43) Pub. Date: Oct. 29, 2026

(54) THRUST REVERSER COMPRISING AN IMPROVED SYSTEM FOR MOVING THE MOVABLE STRUCTURE TOWARDS THE RETRACTED THRUST REVERSAL POSITION THEREOF

(71) Applicant: SAFRAN NACELLES, GONFREVILLE-L'ORCHER (FR)

(72) Inventors: Nicolas Pierre Denis MARIE, MOISSY-CRAMAYEL (FR); Laurent Georges VALLEROY, MOISSY-CRAMAYEL (FR); Vincent Jean-François PEYRON, MOISSY-CRAMAYEL (FR); Pierre Charles CARUEL, MOISSY-CRAMAYEL (FR)

(21) Appl. No.: 19/115,230

(22) PCT Filed: Sep. 29, 2023
(86) PCT No.: PCT/FR2023/051507

§ 371 Date: Mar. 25, 2025

(30) Foreign Application Priority Data
Sep. 29, 2022 (FR) FR2209925

(51) Int. Cl. F02K 1/76; B64D 27/10; B64D 29/00; F02K 1/72

(52) U.S. Cl. CPC F02K 1/76; B64D 27/10; B64D 29/00; F02K 1/72

(57) ABSTRACT

A thrust reverser for an aircraft propulsion assembly, the reverser comprising a stationary structure equipped with a radially inner wall delimiting a secondary flow path, the reverser also comprising a movable structure comprising at least one movable reverser cowling having a cavity delimited between radially outer and inner walls of the movable reverser cowling, the radially outer wall forming an outer aerodynamic surface of the reverser, the movable structure being translatable relative to the stationary structure along a longitudinal central axis of the reverser between a forwards direct thrust position and a retracted thrust reversal position. The inverter also comprises a controlled system for moving the cowling towards the rear into the cavity by injecting outside air through the radially outer wall of the movable inverter cowling.

### TECHNICAL FIELD

The invention relates to the field of nacelles and thrust reversers for an aircraft propulsion unit, and, more particularly, to systems allowing the rearward movement of the movable structure of such reversers.

### PRIOR ART

Thrust reversers are devices for forward deflection of the air flow through the propulsion unit, in order to shorten the landing distances and limit the load on the brakes on the landing gear.

Grille reversers currently operated in the aerospace industry generally comprise deflection grilles incorporated in a fixed reverser structure, intended to be connected to a turbine engine housing. A movable structure of the reverser includes one or more movable reverser cowls, and is mounted movable in translation with respect to the fixed structure between an advanced position of direct thrust, and a retracted position of thrust reversal. In the advanced direct thrust position, the deflection grilles are arranged in a cavity of the moving reverser cowls, and are isolated from the secondary duct of the propulsion assembly by a radially internal wall of the reverser cowls. On the other hand, in the retracted thrust reversal position, the radially retracted internal wall of the reverser cowls defines a passage opening from the secondary duct to the deflection grilles.

To divert at least part of the secondary flow to this passage opening in the direction of the grilles, the reverser is also equipped with closure flaps, which, when deployed, at least partially close the secondary duct. In a known manner, this forces the air from the secondary flow through the passage opening to rejoin the grilles, which then generate the counter-thrust air flow forward.

Solutions for secondary duct closure using deployable membranes also exist. Such a membrane design is for example known from document FR 3,076,864 A1.

In a conventional manner, the moving structure of the reverser is moved backwards towards its retracted thrust reversal position by means of actuators of the hydraulic cylinder or ball screw type actuated by an electric motor, via a flexible shaft. This conventional solution is satisfactory, but the presence of actuators and the means allowing their attachment within the reverser are detrimental to the overall mass of the latter.

To respond to this problem, it has been proposed to use pressurized air from the secondary duct to generate pressure on scooping closure flaps, in order to cause the moving structure to move backwards. However, this solution proves to be complex to implement, and requires particular kinematics for the closure flaps in order to make them scooping, as this kinematics is not necessarily desired by the reverser designer.

### DESCRIPTION OF THE INVENTION

In order to at least partially respond to the disadvantages mentioned above and relating to the previous embodiments, the invention firstly relates to an aircraft propulsion unit thrust reverser, the reverser comprising a fixed structure equipped with a radially internal delimiting wall of a secondary duct of the propulsion unit intended to be passed through by a secondary flow, the reverser also comprising a movable structure comprising at least one movable reverser cowl having a cavity, preferably open to the front, and delimited between a radially outer wall and a radially inner wall of the movable reverser cowl, the radially outer wall forming an outer aerodynamic surface of the reverser, enclosed by external air, the movable structure being movable in translation with respect to the fixed structure along a longitudinal central axis of the reverser, between an advanced position of direct thrust and a retracted position of thrust reversal.

According to the invention, the reverser also comprises a controlled system for moving the movable cowl to the retracted thrust reversal position, by injecting outside air through the radially outer wall of the movable reverser cowl, into said cavity.

The invention thus provides for a controlled system for moving the movable structure based on a simple, reliable, easy to install, and low-mass design. This is because the control allowing outside air to enter the cavity of the movable cowl can be particularly simple to implement, for example in the form of a simple controlled valve, or a controlled lock, as will be detailed later. External air thus easily enters the cavity, under high pressure causing the reverser movable cowl to move backwards.

The controlled movement system firstly generates a pulse at the beginning of the opening travel of the movable structure, towards its retracted thrust reversal position. It can also make it possible to contribute at least partially to moving the movable structure during the continuation of this opening travel. It is noted that during the continuation of this opening travel, other factors and/or means make it possible to ensure the movement to the rear, such as dragging of the air on the aerodynamic outer surface of the movable cowl, the negative pressure at the rear thereof, the introduction of pressurized air from the secondary duct directly into the cavity by the opening caused by the retraction of the cowl, or when the external air rushes by scooping into the opening created at the front of the movable cowl, or the possible presence of an actuator which would then be smaller than those normally encountered. Nevertheless, the invention is preferentially implemented without an actuator for the opening travel in flight, a lower-sized actuator nevertheless being able to be retained for test operations and/or to allow ground maintenance operations with the movable structure in the retracted position. In addition, an actuator may be provided to ensure the closing travel of the movable structure of the reverser, corresponding to its movement from the retracted thrust reversal position, to the advanced direct thrust position.

Finally, the invention does not require the use of closure flaps of the scooping type, but conversely the design of the means for closing the secondary duct remains advantageously free.

The invention preferably provides for at least one of the following optional technical features, taken alone or in combination.

According to a preferred embodiment of the invention, the movement system includes:
at least one scoop provided on the radially outer wall of the movable cowl and designed to scoop outside air;
a controlled valve allowing, in the open position, the circulation of outside air through the scoop and towards said cavity.

According to another preferred embodiment of the invention, the movement system includes:
at least one hatch equipping the radially outer wall, the hatch being designed so as to be able to adopt a closed position, as well as an open position in which it protrudes radially outwards, defining an opening for passing outside air through the radially outer wall;
a controlled device for holding the hatch in the closed position, and releasing said hatch.

Preferably, the movement system also includes elastic means forcing the hatch to its open position, when it is unlocked.

In this preferred embodiment, the protruding position of the hatch in the flow of outside air not only allows air to be injected into the cavity of the movable cowl, but also increases the forces to move this cowl backwards, by the pressure of the air applied to the protruding hatch in the flow of outside air.

Preferably, the number of scoops/hatches is between one and six, distributed circumferentially around the longitudinal central axis (A1), in an even or uneven manner. However, this number may differ, without falling outside the scope of the invention.

Preferably, in the retracted thrust reversal position of the movable structure, the fixed structure of the reverser and an upstream end of the radially retracted inner wall of the reverser movable cowl reveal between them an opening for air to pass through the secondary duct, the thrust reverser also comprising means for closing the secondary duct, designed to divert at least a part of the secondary flow to the passage opening.

Preferably, these closing means comprise at least one closing flap and/or at least one closing membrane.

Preferably, the fixed structure of the reverser comprises at least one deflection grille arranged, in the advanced direct-thrust position of the movable structure, in the cavity of the movable cowl, being isolated from the secondary duct by the radially internal wall of the reverser cowl. Alternatively, the deflection grille or grilles could be incorporated in the movable structure of the reverser, without departing from the scope of the invention.

Preferably, the reverser also includes a device for damping the opening end of travel of the movable cowl, in its movement going from the advanced direct-thrust position to the retracted thrust-reversal position. These damping means may be incorporated in additional cylinders for opening or closing the movable cowl.

Preferably, the reverser includes means for absorbing the counter-thrust forces between the movable structure and the fixed structure, generated on the means for closing the duct and the movable structure. These means may be shared with the damping device and/or the additional opening and closing cylinders, or may be separate means such as stops at the slide rails or dedicated telescopic linkages.

The invention also relates to an aircraft propulsion assembly, comprising a turbine engine and a nacelle comprising at least one fan cowl, as well as a thrust reverser as described above.

The invention also relates to a method for controlling such a thrust reverser. To cause the moving structure to move from its advanced direct-thrust position to its retracted thrust-reversal position, the method comprises a step of controlling the movement system, so that outside air is injected through the radially outer wall, into said cavity of the movable cowl, in order to cause it to move to the retracted thrust-reversal position.

Other advantages and features of the invention will appear in the non-limiting detailed description hereinbelow.

### BRIEF DESCRIPTION OF THE DRAWINGS

The following detailed description refers to the attached drawings on which:

FIG. 1 is a schematic half-view in longitudinal section of a propulsion unit, comprising a thrust reverser according to a preferred embodiment of the invention, shown in a direct thrust configuration;

FIG. 2 is a schematic half-view in longitudinal section of the reverser equipping the propulsion unit shown in FIG. 1, with the reverser shown in direct thrust configuration;

FIG. 3 is a schematic half-view of the reverser shown in FIG. 2, shown in thrust reversal configuration;

FIG. 3A is a schematic half-view similar to that of the previous figure, with the reverser being according to an alternative embodiment;

FIG. 4 is a perspective view of the reverser shown in FIGS. 2 and 3, shown in a direct thrust configuration;

FIG. 5 is a perspective view of the reverser shown in FIG. 4, shown in thrust reversal configuration;

FIG. 6 is a schematic half-view in longitudinal section similar to that of FIG. 2, showing the controlled system for moving the movable cowl in more detail, and being in the form of a preferred embodiment of the invention;

FIG. 7 is a schematic half-view in longitudinal section similar to that of FIG. 6, with the reverser still shown in direct thrust configuration, but just before the beginning of the opening travel of the movable reverser cowls;

FIG. 8 is a schematic half-view in longitudinal section similar to that of FIG. 6, with the reverser shown in thrust reversal configuration;

FIG. 9 is a schematic half-view in longitudinal section similar to that of FIG. 2, with the reverser being in the form of another preferred embodiment of the invention;

FIG. 10 is a schematic half-view in longitudinal section similar to that of FIG. 9, with the reverser still shown in direct thrust configuration, but just before the beginning of the opening travel of the reverser movable cowls;

FIG. 11 is a schematic half-view in longitudinal section similar to that of FIG. 9, with the reverser shown in thrust reversal configuration;

FIG. 12 is a schematic half-view in longitudinal section similar to that of FIG. 11, with the reverser being in the form of an alternative;

FIG. 13 is a schematic view showing the hinge of the hatch of the embodiment of FIGS. 9 to 11, on the outer wall of the movable reverser cowl.

### DESCRIPTION OF THE EMBODIMENTS

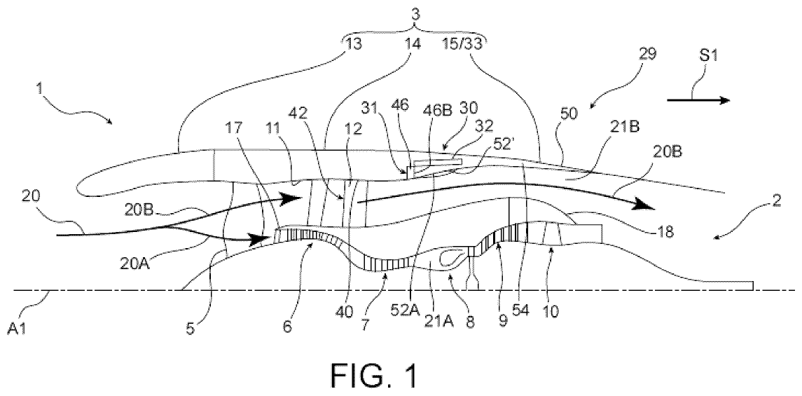

An aircraft propulsion unit 1 is shown in FIG. 1, having a longitudinal central axis A1.

Subsequently, the terms “upstream” and “downstream” are defined relative to a general direction S1 of flow of gases through the propulsion unit 1, along the axis A1 when it generates a thrust. These terms “upstream” and “downstream” may be replaced by the terms “front” and “rear”, respectively, with the same meaning.

The propulsion unit 1 comprises a turbine engine 2, a nacelle 3 and a mast (not shown), intended to connect the propulsion unit 1 to a wing (not shown) of the aircraft.

The turbine engine 2 is in this example a bypass twin-spool turbojet comprising, from the front to the rear, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet 2 has a fan housing 11 connected to the gas generator by structural arms 12.

The nacelle 3 comprises a front section forming an air inlet 13, a middle section that includes two fan cowls 14 enveloping the fan housing 11, and a rear section 15.

In operation, an air flow 20 enters the propulsion unit 1 through the air inlet 13, passes through the fan 5 and then divides into a primary flow 20A and a secondary flow 20B. The primary flow 20A flows into a primary gas circulation duct 21A passing through the gas generator. The secondary flow 20B flows into a secondary duct 21B surrounding the gas generator. The secondary duct 21B is delimited radially inwards by a fixed internal fairing that surrounds the gas generator. In this example, the fixed inner fairing comprises a first portion 17 belonging to the middle section 14, and a second portion 18 extending backwards from the first portion 17, so as to form a part of the rear section 15. This second portion 18 is an integral part of a fixed structure of a thrust reverser which will be described below. This same portion will subsequently be referred to as the radially internal delimiting wall 18 of the secondary duct 21B.

Radially outwards, the secondary duct 21B is delimited by the fan housing 11, and, in the configuration of FIG. 1, by one or more movable reverser cowls 33 forming a part of the rear section 15 of the nacelle 3, and which will be described later. More precisely, between the fan housing 11 and the reverser cowls 33, an outer collar 40 of an intermediate housing 42 is provided, the latter comprising the aforementioned structural arms 12, the radially outer end of which is fastened to this collar 40. It therefore also contributes to delimiting the secondary duct 21B radially outwards, by being located in the axial extension downstream of the fan housing 11.

The nacelle 3 therefore includes a thrust reverser 30 centered on the axis A1 and comprising, on the one hand, a fixed structure 31 integral with the fan housing 11, and, on the other hand, a structure 29 movable with respect to the fixed structure 31. The fixed structure 31 includes for example a front frame 46 which fixedly connects it to the fan housing 11, preferably via a knife flange assembly located downstream of the outer collar 11. This front frame 46 contains a profiled aerodynamic part called the deflection edge 46B, which guides the reverse jet flow.

Here, the fixed structure 31 also includes a plurality of deflection grilles 32 arranged adjacent to one another around the axis A1, in a circumferential direction of the reverser 30 and the propulsion unit 1. Furthermore, the movable structure 29 for its part comprises the aforementioned movable reverser cowls 33, for example two cowls 33 each extending over an angular amplitude of about 180°. This two-cowl configuration 33 is particularly well the adapted in the case of a nacelle design in which the cowls/walls 18 are also mounted articulated, the reverser 30 then having a so-called “D” architecture, known by the English term “D-Duct”. In this architecture, the cowls 18, 33 are connected so as to open/close simultaneously during maintenance operations on the engine. Nonetheless, other architectures are possible, such as a so-called “C” architecture, known by the English name “C-Duct”, or a so-called “O” architecture, known by the English name “O-Duct”.

Each movable reverser cowl 33 includes a radially external wall 50, forming an external aerodynamic surface of the reverser and of the nacelle, this surface being enclosed by the outside air. Each cowl 33 also comprises a radially inner wall 52 participating in the delimitation of the secondary duct 21B radially outwards. This wall 52 is located in the downstream continuity of the outer shell 40 of the intermediate housing. The two walls 50, 52 define a cavity 54 preferably open axially forwards, at the upstream end of the reverser cowl 33.

FIG. 1 shows the reverser 30 in a forward thrust configuration, known as a “direct jet”, corresponding to a standard flight configuration. In this configuration, the cowls 33 of the movable structure 29 are in a closed position, a so-called advanced thrust or “direct jet” position, in which these reverser cowls 33 are supported on the fixed structure 31, in particular on the deflection edge 46B forming an integral part thereof. This is because, in the direct thrust configuration, the upstream end 52a of the radially inner wall 52 of each cowl 33 is in axial abutment against the deflection edge 46B.

The holding of the movable cowl 33 in the forward position of direct thrust is ensured by means of locking this cowl on the fixed structure 31 of the reverser. These controlled locking means (not shown) are conventional, so they will not be described further. By way of indicative example, active locks capable of unlocking under load may be implemented to counteract the compressive force of a seal between the movable structure and the deflection edge. This type of lock can overcompress the seal so that the unlocking can then be controlled. The movable structure 29 can thus be moved in translation with respect to the fixed structure 31 along the axis A1 of the reverser, between the advanced position of direct thrust shown in FIG. 1, and a retracted position of thrust reversal which will be described later. In the advanced direct thrust position of the movable structure 29, the deflection grilles 32 are arranged in the cavity 54 of the reverser cowls 33, being isolated from the secondary duct 21B by the radially inner wall 52 of these sliding reverser cowls 29. This wall 52, forming the outer wall of the secondary duct, is also called the acoustic inner panel.

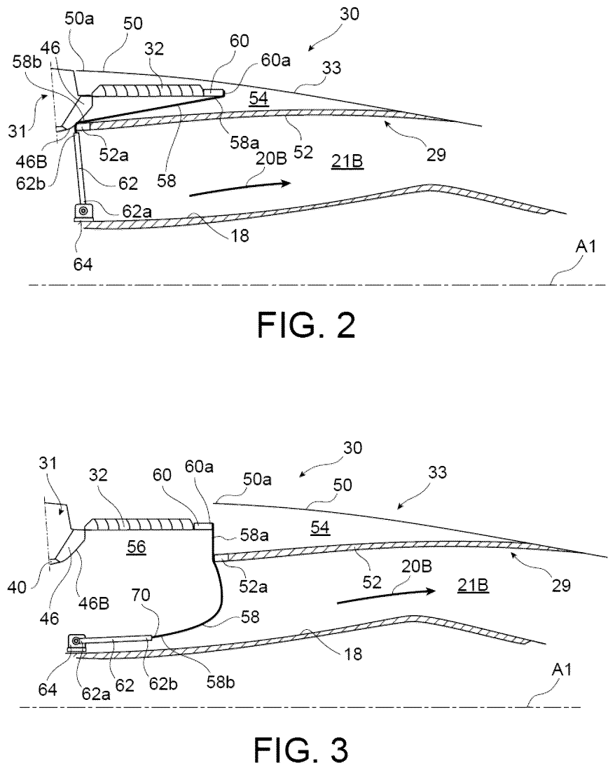

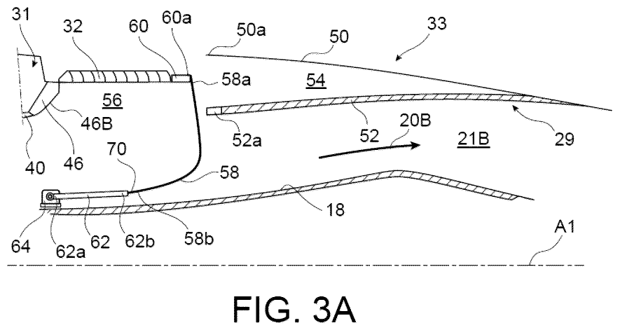

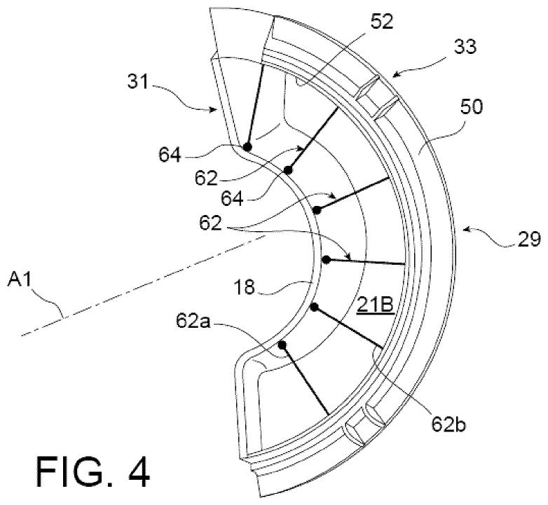

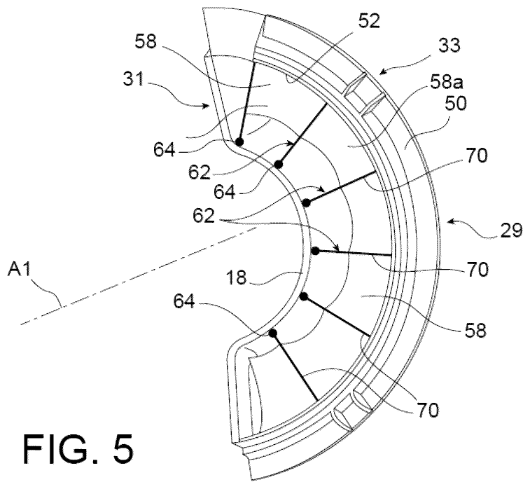

This direct thrust configuration is also shown in FIGS. 2 and 4, while the retracted thrust reversal position of the movable structure 29 is shown in FIGS. 3 and 5. In FIG. 3, it is shown that the retracted internal acoustic panel 52 of the reverser cowls leaves upstream a passage opening 56 from the secondary channel 21B to the deflection grilles 32. The opening 56 is therefore also delimited upstream by the deflection edge 46B, which splays radially outwards going towards the rear, to channel an air flow intended to pass through the grilles 32 when the movable system is in this rearward thrust reversal position. In other words, the deflection edge 64 gradually moves away from the axis A1 going from the front to the rear, to guide/deflect the air towards the grilles 32 in the thrust reversal configuration. Downstream, the passage opening 56 is delimited in particular by the upstream end 52a of the radially inner wall 52.

In order to divert at least a portion of the secondary flow 20B to the passage opening 56 defined axially between the deflection edge 46B and the upstream end 52a of the radially inner wall 52 of each cowl 33, the reverser 30 comprises in this preferred embodiment one or more closing membranes 58. Subsequently, an embodiment will be described in which a single membrane 58 is associated with each reverser cowl 33 having an identical or similar angular amplitude, but it remains conceivable to provide several circumferentially adjacent membranes associated with each cowl 33. Similarly, only the cooperation between one membrane 58 and its associated cowl 33 will be described hereinafter, it being understood that this cooperation is identical or similar for all the cowls of the reverser 33.

The membrane 58 may be made of a material known to those skilled in the art for this type of application. For example, it may be an unimpregnated fabric, for example aramid fibers. The membrane 58 can also be made using a composite material the matrix of which is particularly flexible, for example made of aliphatic polyurethane, which allows use under different temperature conditions, in particular lower temperatures in the case of an aliphatic polyurethane membrane than in the case of a silicone membrane. The matrix gives a low flexural recovery capacity and the behavior of the structure obtained is indeed that of a membrane. One of the major properties of this membrane 58 is to be able to be folded perfectly reversible (elastically or by sliding fibers) with a very small radius of curvature relative to its surface, and to have a very small thickness, for example of the order of 0.1 to 3 mm. For information, it is observed that this membrane 58 behaves like a boat sail or a parachute/flying wing when it is pressurized.

Still with reference to FIGS. 1 to 5, first attachment means are provided connecting a first end 58a of the closing membrane 58 to a rear frame 60 supporting the grilles 32, this annular support or annular section-shaped support effectively connecting the rear end of several adjacent grilles. In addition, second attachment means connect a second end 58b of the closing membrane 58, opposite to the first membrane 58a, to the wall 18.

Furthermore, as can be seen in FIGS. 1, 2 and 4, when the movable structure 29 occupies its forward position of direct thrust, at least a portion of the closing membrane 58 is arranged radially between the deflection grilles 32 and the radially inner wall 52 of the reverser cowl 33, in the cavity 54. Preferably, the portion of the membrane 58 that is in this cavity 54 of the reverser cowl 33 radially cowls the entire length of the grilles 32. Thus, when the movable structure 29 adopts its advanced position of direct thrust, the second end 58b of the membrane 58 is gripped between the upstream end of the wall 18 and the deflection edge 46B. In order to avoid possible damage to the membrane 58 due to this gripping, the deflection edge 46B can locally have a notch with a shape adapted to receive the upstream end 52a of the wall 52. Thus the membrane 58 is also pressed in this notch of the deflection edge 46B, by the abutment of the upstream end of the wall 52.

Similarly, as can be seen in FIG. 3, when the movable structure 29 moves and occupies its rearward position of thrust reversal at the end of this movement, the closing membrane 58 is partially supported against the upstream end 52a of the radially internal wall 52 of the reverser cowl, thus corresponding to the acoustic panel. More precisely, during the rearward movement of the movable structure 29, the membrane 58 slides on this upstream end 52a of the radially inner wall 52.

In the retracted thrust reversal position of FIG. 3, the membrane 58 is therefore axially supported downstream against the upstream end 52a. It should be noted that, depending on the extent of the axial travel of the reverser, the membrane 58 may no longer be in contact with the internal acoustic panel 52 in the fully deployed position of the reverser, where the cowl 33 is in its most retracted position. Such a configuration is shown in FIG. 3A, in which it is shown that the membrane 58 is upstream and at a distance from the upstream end 52a of the wall 52 of the reverser cowl. The contact option corresponds to a minimized reverser travel, whereas the non-contact option generally corresponds to a smoother diaphragm shape in reversed jet, thus performing better aerodynamically.

Thus the portion of the membrane 58 that is located radially outwards with respect to its zone bearing on the wall 52 closes off a portion of the upstream axial opening of the cavity 54, while the other portion located radially inwards closes off at least a portion of the secondary duct 21B, thereby diverting at least a portion of the secondary flow 20B towards the passage opening 56 in the direction of the grilles 32.

Another possibility, not shown, consists in carrying out the radially external attachment of the membrane 58 on the radially external wall 50 of the sliding cowl 33. The end 58b of the membrane 58, for its part, has cables 70 connected to the wall 18 (also referred to as IFS, from the English “Inner Fixed Structure”), by a connection which can advantageously exert a tensile force on each cable 70 returning it towards this wall 18, for example by means of an elastic connection. The cables 70 themselves can be elastic, for example by using Kevlar cables, and these same cables can be tensioned when the sliding cowl 33 is closed. Reinforcements may be Integrated into the membrane 58 in line with these cables 70, up to the external attachment points with the rear grille support frame 60, or the outer wall 50 of the sliding cowl 33.

These cables 70 are advantageously positioned radially in the duct while being circumferentially spaced apart from each other. In the direct jet position, they tension the membrane 58 between its end 58a and the leading edge/upstream end 52a of the wall 52 of the cowl. During deployment, when the sliding cowl 33 retracts, the cables 70 pull the membrane 58 towards the secondary duct so that it takes air therein and gradually deploys therein.

Depending on the purpose sought, the second attachment means may be made up of connecting rods 62, instead of the cables mentioned above. A first end 62a of each of them is mounted on the wall 18, preferably via a pivot or ball joint connection 64. This connection 64 can be made using a fitting fixed to the fixed wall 18 and cooperating with the first connecting rod end 62a.

The connecting rods 62 are circumferentially spaced from one another within the secondary duct 21B, and their number can for example vary from two to ten.

Each connecting rod 62 is designed to move from a radially projecting position in the secondary duct 21B, the position shown in FIGS. 2 and 4 adopted when the movable structure 29 occupies its advanced direct-thrust position, to a position folded downstream, shown in FIGS. 3 and 5 adopted when the movable structure 29 occupies its rearward thrust-reversal position.

Elastic return means can be provided to tend to tilt each connecting rod 62 towards its folded/lying position of FIG. 3, in particular when the connecting rod is in its projecting position corresponding to the flight position of the reverser.

The second end 62b of each connecting rod 62, opposite the first end 62a, can be connected directly to the second end 58b of the membrane 58. Nonetheless, other preferential solutions are adopted, such as those aimed at incorporating cables or reinforcement straps within the second means of attachment.

In the embodiment shown in FIGS. 1 to 5, the cables 70 cooperate with the connecting rods 62 while each being attached to the second end 62b of one of the connecting rods associated with this cable. Alternatively, the cables 70 could pass through their associated connecting rods 62 to be attached to the radially internal delimiting wall 52 of the secondary duct, for example via the fittings 66.

It is recalled that, in a conventional grille reverser, the movable structure slides relative to the fixed structure by means of a rail/slide system that guides the movable structure from the front to the rear during the reverser opening phase, and from the rear to the front during the closing phase. A rearward force applied to the moving structure of the reverse reverser therefore causes its movement to the rear, with respect to the fixed structure. This force is usually generated by conventional actuators such as cylinders or ball screws.

By contrast, one of the particularities of the invention lies in the fact that the reverser is not equipped with conventional actuators allowing the moving structure 29 to be moved backwards, from its advanced direct-thrust position to its retracted thrust-reversal position. In other words, unlike conventional designs, there is no provision for a cylinder or ball screws intended to generate and control the entire opening travel of the movable cowls 33 to the retracted thrust reversal position, between their two extreme positions. Consequently, there is also no provision for a motor or pump that would provide the hydraulic, electrical or pneumatic energy to actuate these cylinders or ball screws.

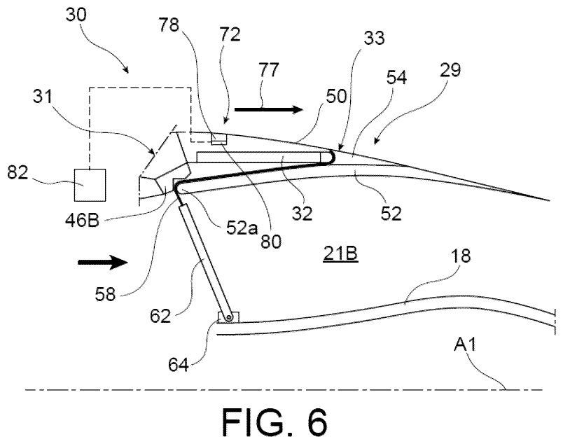

Specific means are thus provided to cause the rearward movement of each movable cowl 33, as will be described below with reference to FIGS. 6 to 8, corresponding to other more detailed views of the reverser according to the preferred embodiment previously described with reference to FIGS. 1 to 5.

The reverser comprises in fact, for each movable cowl 33, a controlled system for moving 72 this movable cowl backwards, by injecting outside air through the radially outer wall 50 of the cowl, into its cavity 54.

To this end, the system 72 is first of all equipped with at least one scoop 78, provided on the radially outer wall 50 and preferably forming an integral part thereof, preferentially being arranged on an upstream portion of this wall. This scoop 78, preferably of dynamic design, for example of the NACA type (developed by the National Advisory Committee for Aeronautics), is designed to scoop outside air into the outside air flow 77 circulating around the nacelle, in the direction S1. Preferably, there are several scoops 78 that equip the wall 50 of each cowl, for example up to six scoops per cowl 33, distributed circumferentially in an even manner or not around the axis A1.

In addition, each scoop 78 is associated with a controlled valve 80 allowing, in the open position, the circulation of pressurized external air through the scoop. In this respect, it is noted that the scoop 78 can open directly into the cavity 54 of the cowl, in which case the controlled valve 80 can be incorporated in the scoop, or attached to the end thereof. According to another possibility, the scoop 78 is extended by an injection duct (not shown), provided for example to direct the taken-off outside air in the direction of the downstream bottom of the cavity 54. In this case, the controlled valve 80 can also be implanted on this injection duct, without departing from the scope of the invention.

The valve 80 is controlled by a valve control system 82, for example the FADEC type (corresponding to the English acronym of “Full Authority Digital Engine Control”). The control system 82 is capable of delivering an electrical signal to the valve so as to switch it from an open position to a closed position, and vice versa.

In flight, when the reverser is in direct thrust configuration, the valve 80 is held in the closed position by the control system 82. As a result, nothing is taken from the external air flow 77 by the scoop 78.

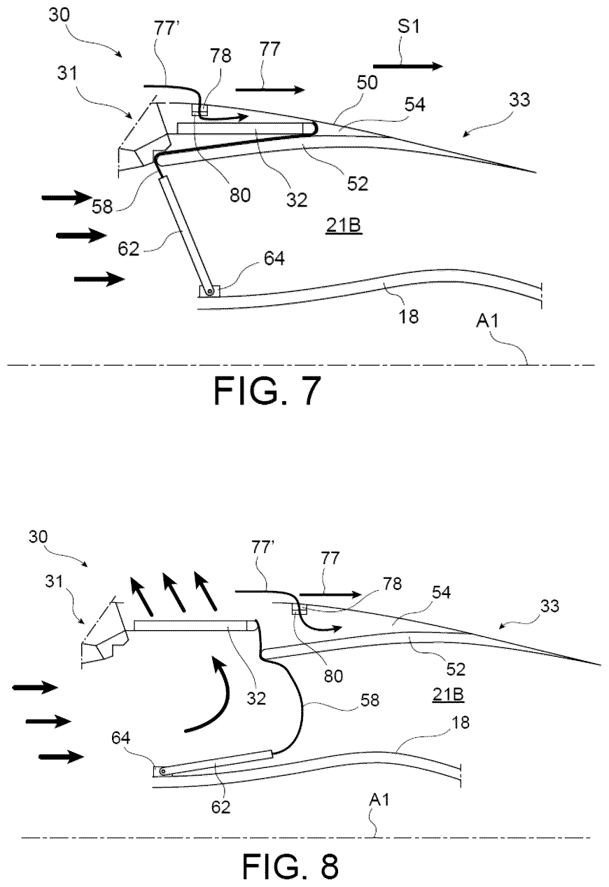

When the reverser is to be switched into the thrust reversal configuration, a movement of the movable structure 31 from its advanced direct-thrust position to its rearward thrust-reversal position is carried out, and for this purpose, not only is an unlocking of each movable cowl 33 with respect to the fixed structure 31 of the reverser carried out, but also a step of controlling the valve 80. In fact the control system 82 opens the valve 80, so that the scoop 78 can fulfill its function by scooping a portion 77′ of the external flow 77, as has been schematized in FIG. 7. This enables the pressurized outside air 77′ taken to circulate through the wall 50 via its scoop 78, and therefore enables this outside air to be injected into the cavity 54. Due to the high pressure of this outside air on the surfaces of the walls 50, 52 of the cowl 33 inside the cavity 54, there is a movement of this cowl 33 backwards towards its retracted thrust reversal position.

Thus the controlled movement system 72 specific to the invention makes it possible to generate a pulse at the beginning of the opening travel of the movable cowl 33 in a simple, reliable and efficient manner. The pressure of the air coming from the scoop 78 can also contribute to moving the movable cowl during the continuation of this opening travel, even after a significant opening or a total opening of the movable structure 33, as shown in FIG. 8.

The further opening travel of the movable cowl 33 is nevertheless preferably carried out under the effect of other principles, such as the air drag on the outer aerodynamic surface of the wall 50, or the negative pressure observed at the rear of the cowl 33, or the introduction of the pressurized air from the secondary duct directly into the cavity via the opening caused by the retraction of the translating panel, or when external air rushes by scooping into the opening created at the front of the translating external panel. An actuator of a conventional type, but of a small size, could nevertheless be retained to provide this end-of-travel opening in flight, even if this is not the preferred solution. The presence of such a smaller-sized actuator could also be justified to perform test operations before flight, and/or to allow ground maintenance operations with the movable structure 29 in the retracted position.

In addition, an actuator can be provided to provide the closing travel of the movable structure 29, corresponding to its movement from the retracted thrust-reversal position, to the advanced direct-thrust position.

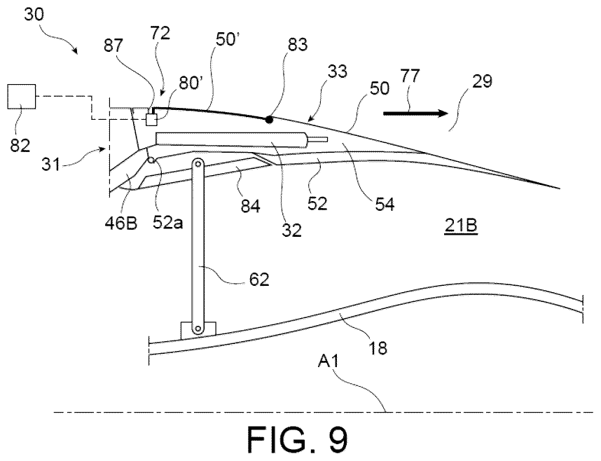

FIGS. 9 to 11 the show another preferred embodiment of the invention, wherein the means for closing the secondary duct 21B are implemented using flaps 84, the latter being for example each articulated at one of its ends on the upstream end 52a of the wall 52, and also articulated in a central area on a connecting rod 62, itself articulated on the wall 18. In this configuration, these are conventional, non-scooping closure flaps 84. In this respect, it is noted that these conventional closure means, of the flap type 84, may moreover be preferred over the membrane solution described in relation to the previous figures. Moreover, all the characteristics specific to the various preferred embodiments of the invention can be implemented with closure flaps 84.

It is noted that a mixed solution incorporating both flaps and membranes for closing the duct remains possible, without departing from the scope of the invention.

In the preferred embodiment of FIGS. 9 to 11, the movement-controlled system 72 takes a different shape, since the scoops 78 are replaced by one or more hatches 50′ equipping the radially outer wall 50, thus preferably forming an integral part thereof. Each hatch 50′ is articulated at its rear end on the main part of the wall 50, in an articulation 83 oriented parallel or substantially parallel to a circumferential/tangential direction of the reverser, relative to the axis A1.

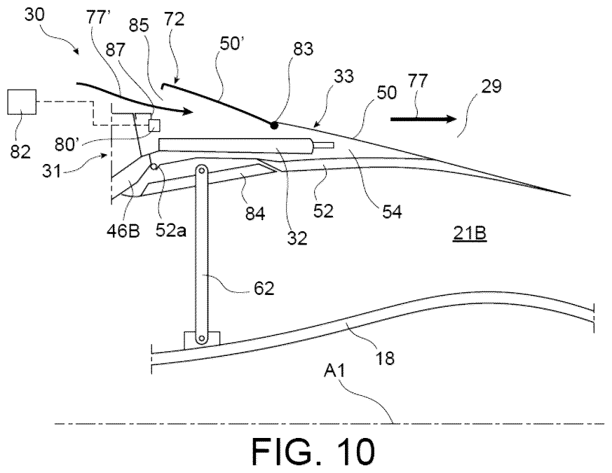

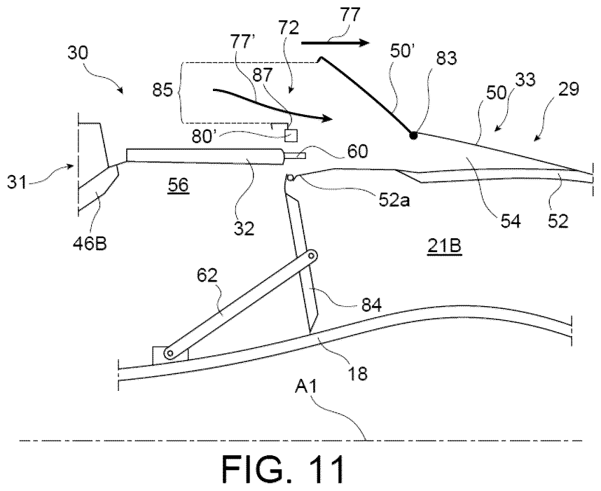

The hatch 50′ is designed so as to be able to adopt a closed position as shown in FIG. 9 and adopted in direct jet, as well as an open position as shown in FIGS. 10 and 11.

In the open position, the hatch 50′ protrudes radially outwards with respect to the main part of the wall 50 on which it is articulated. Therefore, with its front end axially and radially offset from the main part of the wall 50, the hatch defines with the latter an opening 85 for passing outside air through the wall 50, in the direction of the cavity.

Each hatch 50′ is associated with a controlled device allowing the hatch to be held in the closed position, and releasing the same hatch when its opening in the external flow 77 is desired. This device can be a simple controlled lock 80′, interposed between the front end of the hatch 50′, and the main part of the wall 50 at a cutout 87 thereof, closed by the hatch 50′ in the closed position.

Here too, the lock 80′ can be controlled by the system 82 shown very schematically in FIG. 9.

In flight, when the reverser is in direct thrust configuration, the lock 80′ keeps the hatch 50′ in the closed position, via the control system 82. As a result, no external air flow 77 is taken via the hatch 50′. The hatch 50′ is then aerodynamically continuous with the outer surface of the wall 50.

When the reverser is to be switched into the thrust reversal configuration, a movement of the movable structure 31 from its advanced direct-thrust position to its retracted thrust-reversal position is made, and for this purpose not only an unlocking of each movable cowl 33 with respect to the fixed structure 31 of the reverser is implemented, but also a step of controlling the lock 80′. In fact, the control system 82 opens the lock 50′, causing the hatch 50′ to open either due to an elastic system forcing this hatch 50′ to its open position, for example implanted in the seal 83, and/or due to the action of the external air flow on the front end of this hatch, which tends to rise.

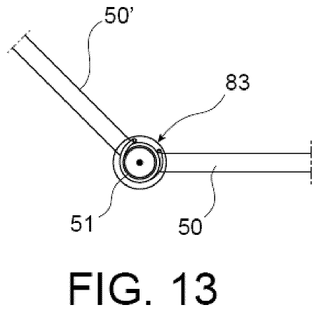

The movement system 72 can therefore also include elastic means forcing the hatch 50′ to its open position, when it is unlocked. These elastic means 51 can for example be torsion springs located in the articulation hinges 83 of the hatch 50′, as has been shown schematically in FIG. 13. Alternatively/simultaneously, linear elastic means may be provided located between the hatch 50′ and the movable cowl 33, or incorporated in the lock 80′ of this hatch.

From the beginning of the pivoting of the hatch 50′ via its articulation 83, it releases an opening 85 through which a portion 77′ of the external flow 77 can pass, in the direction of the inside of the cavity 54, as shown schematically in FIG. 10. This effectively enables the pressurized external air sample 77′ to circulate through the wall 50 via the opening 85, and thus allows the injection of this external air into the cavity 54. Due to the high pressure of this outside air on the surfaces of the walls 50, 52 of the cowl 33 inside the cavity 54, there is a movement of this cowl 33 backwards towards its retracted thrust reversal position. The movement to the rear also results from the pressure of the external air acting on the hatch 50′ protruding into the external air flow 77.

Thus the controlled movement system 72 makes it possible to generate a pulse at the beginning of the opening travel of the movable cowl 33 in a simple, reliable and efficient manner. The pressure of the air injected into the cavity 54 can also contribute to moving the movable cowl during the continuation of this opening travel, even after a large opening or a complete opening of the movable structure 33, as shown in FIG. 11. The same applies to the force applied to the cowl 33, emanating from the pressure of the external air on the hatch 50′ projecting into the external air flow 77.

The continuation of this opening travel of the movable cowl 33 is also preferably carried out under the effect of other principles, such as the drag of the air on the outer aerodynamic surface of the wall 50, or the negative pressure observed at the rear of the cowl 33, or the introduction of the pressurized air from the secondary duct directly into the cavity by the opening caused by the retraction of the translating panel, or when external air rushes in by scooping through the opening created at the front of the translating external panel. Here too, a conventional but small-sized actuator could be kept to provide this end of opening travel in flight, even if this is not the preferred solution. The presence of such a smaller-sized actuator could also be justified to perform test operations before flight, and/or to allow ground maintenance operations with the movable structure 29 in the retracted position.

In addition, an actuator can also be provided herein to ensure the closing travel of the movable structure 29, corresponding to its movement from the thrust reversal rearward position, to the advanced direct thrust position.

Of course, in the two preferred embodiments just described, the design of the means for closing the secondary duct remains interchangeable.

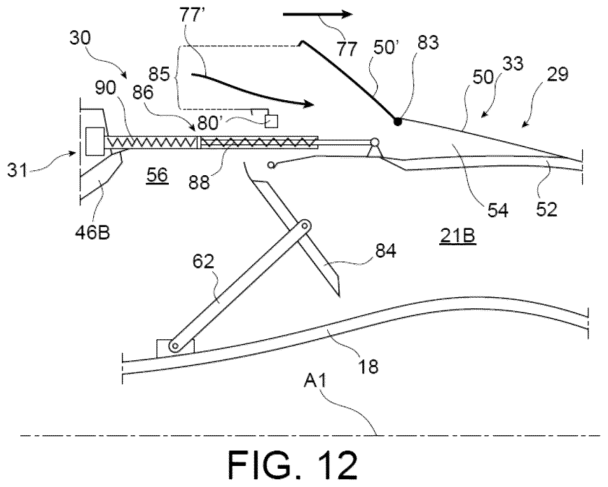

Finally, FIG. 12 shows an alternative applicable to all preferred embodiments. Between the fixed structure 31 and the movable structure 29, a damping device 86 is provided for the end of opening travel of the movable cowl 33, for example in the form of a mechanical cylinder equipped with one or more damping springs 88. Within this device 86, or in a separate device, mechanical means for pulsing the opening travel of the movable cowl 33 can also be provided, preferably also in the form of elastic means such as one or more impulse springs 90. The device 86 can for example be implanted circumferentially between the deflection grilles 32 (not shown in FIG. 12), and it is one or more of these devices 86 that equip each of the two movable cowls 33.

These damping means may be incorporated into additional opening or closing cylinders or ball screws. Preferably, the reverser includes means for absorbing the counter-thrust forces between the movable structure and the fixed structure generated on the means for closing the duct and the movable structure. These means may be shared with the damping device and/or the additional opening and closing cylinders, or may be separate means such as stops at the slide rails or dedicated telescopic linkages.

Various modifications may be made by a person skilled in the art to the invention just described, only by way of non-limiting examples, and the scope of which is defined by the appended claims. For example, the thrust reverser 30 may alternatively have a “C” or “O” architecture. Furthermore, if the preferred embodiments described above relate to a design of a reverser with fixed deflection grilles, these grilles may alternatively be incorporated in the movable structure of the reverser.

What is claimed is:

1. A thrust reverser for an aircraft propulsion unit, the reverser comprising a fixed structure equipped with a radially inner delimiting wall of a secondary duct of the propulsion unit intended to be traversed by a secondary flow, the reverser also comprising a movable structure comprising at least one movable reverser cowl having a cavity delimited between a radially outer wall and a radially inner wall of the reverser movable cowl, the radially outer wall forming an outer aerodynamic surface of the reverser, enclosed by external air, the movable structure being movable in translation with respect to the fixed structure along a longitudinal central axis of the reverser, between an advanced position of direct thrust and a retracted position of thrust reversal,
characterized in that the reverser also comprises a controlled system for moving the movable cowl to the retracted thrust reversal position, by injecting external air through the radially outer wall of the movable cowl of the reverser, into said cavity.

2. The thrust reverser according to claim 1, wherein the movement system includes:
at least one scoop provided on the radially outer wall of the movable cowl and designed to scoop outside air;
a controlled valve allowing, in the open position, the circulation of external air through the scoop and towards said cavity.

3. The thrust reverser according to claim 1, wherein the movement system includes:
at least one hatch equipping the radially outer wall, the hatch being designed so as to be able to adopt a closed position, as well as an open position in which it protrudes radially outwards, while defining an opening for passing outside air through the radially outer wall;
a controlled device for holding the hatch in the closed position, and releasing said hatch.

4. The thrust reverser according to claim 3, wherein the movement system also includes elastic means forcing the hatch towards its open position, when it is unlocked.

5. The thrust reverser according to claim 1, wherein the number of scoops (78)/hatches is between one and six, distributed circumferentially around the longitudinal central axis.

6. The thrust reverser according to claim 1, wherein in the retracted thrust reversal position of the movable structure, the fixed structure of the reverser and an upstream end of the retracted radially inner wall of the movable reverser cowl reveal between them a passage opening for air through the secondary duct, the thrust reverser also comprising means for closing off the secondary duct, designed to divert at least a portion of the secondary flow toward the passage opening.

7. The thrust reverser according to claim 1, wherein the fixed structure of the reverser comprises at least one deflection grille arranged, in the advanced position of direct thrust of the movable structure, in the cavity of the movable cowl, being isolated from the secondary duct by the radially inner wall of the reverser cowl.

8. The thrust reverser according to claim 1, wherein further comprising also includes a device for damping the end of opening travel of the movable cowl, in its movement from the advanced position of direct thrust to the retracted position of thrust reversal.

9. An aircraft propulsion unit (1), comprising a turbine engine and a nacelle including at least one fan cowl, as well as the thrust reverser according to claim 1.

10. A method for controlling the thrust reverser according to claim 1, wherein, to drive the movement of the movable structure from its advanced position of direct thrust to its retracted position of thrust reversal, the method comprises a step of controlling the movement system, so that external air is injected through the radially outer wall, into said cavity of the movable cowl, in order to cause it to move to the retracted thrust reversal position.
